(19) United States
(12) Patent Application Publication
(10) Pub. No.: US 2014/0258169 A1
(43) Pub. Date: Sep. 11, 2014

(54) METHOD AND SYSTEM FOR AUTOMATED VERIFICATION OF CUSTOMER REVIEWS

(71) Applicants: Bental Wong, Portland, OR (US); Rebekah Wong, Portland, OR (US)

(72) Inventors: Bental Wong, Portland, OR (US); Rebekah Wong, Portland, OR (US)

(21) Appl. No.: 13/784,844

(22) Filed: Mar. 5, 2013

(51) Int. Cl. G06Q 30/02

(52) U.S. Cl. CPC G06Q 30/0282
USPC 705/347

(57) ABSTRACT

Described embodiments provide systems and methods for verifying customer reviews. Certain embodiments evaluate the authenticity of a proof-of-purchase provided by a customer. Other embodiments may provide an electronic service that verifies the authenticity of a proof-of-purchase provided by a customer to document a transaction between the customer and a merchant.

This application claims the benefit of filing of U.S. Provisional Patent Application No. 61/612,532, filed Mar. 19, 2012, entitled “METHOD AND SYSTEM FOR VERIFICATION OF CUSTOMER REVIEWS”, the teachings of which are incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to a computerized arrangement for the analysis and detection of fraudulent user reviews and more particularly, to a computerized system that verifies a user review by evaluating the authenticity of a proof-of-purchase provided by the user.

The present inventors have recognized that online reviews are an important aspect of the decision making process for many consumers and that reviews are featured prominently on leading local directory websites such as YellowPages.com, Yahoo! Local, SuperPages.com and CitySearch.com. The present inventors have also recognized that online reviews typically suffer from reliability concerns because many websites allow users to submit reviews with no verification or insufficient verification that the user actually conducted business with the merchant that being reviewed. In fact, there are many examples of merchants posing as a customer and submitting positive reviews for themselves or submitting negative reviews for their competitors.

Typical attempts to alleviate the problem of unverified reviews focus on verifying that the reviewer is a real person. For example, Yelp.com encourages users to use real names on their profile as well as invite friends from their social networks in an attempt to encourage real reviews from real persons. However, the present inventors have recognized that such an approach only infers that the review is legitimate since it is submitted by a real person, but does not actually verify that the person actually conducted a transaction with the merchant being reviewed. The Gartner Group, in a press release dated Sep. 17, 2012, estimates that 10-15% of social media reviews are fake and paid for by companies. Additionally, requiring users to disclose their identities on publicly accessible website exposes the user to identity theft and other privacy risks.

Other approaches, such as those being developed by Microsoft and Cornell University, focus on detecting falsified reviews by examining the textual content of the reviews. The present inventors have recognized that such approaches infer that reviews that are written well are legitimate, but may lead to reviews that are incorrectly classified as a false review simply due to the reviewer's writing style. The present inventors have also recognized that, given the relative ease of modifying writing style and content, adept writers of false reviews could learn what text structures are acceptable and generate false reviews that are classified as genuine. Furthermore, the present inventors have recognized that such approaches may not work for short reviews because of the relative lack of text to analyze, which may be problematic because often a short summary captures the entire experience adequately, e.g. “Had a great time!”.

Another approach, such as the one used by ResellerRatings.com, includes working with e-commerce websites to generate verified reviews by integrating an exit survey into the website's checkout process. Such an approach may be a systematic way of polling customers for reviews, but requires systems integration. The present inventors have recognized that such an approach results in incomplete coverage of retailers because few retailers have integrated with systems like ResellerRatings. This problem is more pronounced for brick-and-mortar retailers since they often employ complex point-of-sale transaction systems that are difficult to integrate with systems like ResellerRatings.

### BRIEF SUMMARY OF THE INVENTION

Described embodiments provide systems and methods for verifying customer reviews. Certain embodiments evaluate the authenticity of a proof-of-purchase provided by a customer. Other embodiments may provide an electronic service that verifies the authenticity of a proof-of-purchase provided by a customer to document a transaction between the customer and a merchant.

The described embodiment improves the accuracy of false review detection by directly analyzing a submitted proof-of-purchase instead of inferring validity based on the user identity or writing style. Other features of the described embodiment include allowing customers to submit reviews and proof-of-purchases without having personally identifying information revealed to other users or merchants in order to protect their privacy; accepting both merchant-issued receipts and bank-issued account statements such as credit card statements or demand deposit account statements as proof-of-purchase and verifying reviews regardless of the length or quality of the review text by focusing on the proof-of-purchase provided.

While the described systems and methods may be useful for verifying merchant reviews, those skilled in the art will recognize that the described systems and methods may be used in virtually any situation where transaction verification is required. For example, instead of being used for merchant reviews, the described systems and methods may be used for product reviews, product rebate claims, special offer qualification, customer surveys, warranty re-imbursement claims, medical expense claims, employee expense reports, construction and home improvement loan disbursement requests, financial statement audits, taxation authority audits, etc. Additionally, while the described systems and methods use merchant issued receipts and bank issued transaction records (statements) as proof-of-purchase for a review, those skilled in the art will recognize that the described systems and methods may use any other suitable documents that are document the occurrence of a transaction such as invoices, billing statements, account summaries, remittal advice, service agreements, lease agreements, letter agreements, contracts, email receipts, and other suitable electronic or paper documentation. Additionally, while the described systems and methods analyze the text data contained on the proof-of-purchase, those skilled in the art will recognize that additional data that is contained on the proof-of-purchase can be analyzed and used within the system, such as graphical images.

The foregoing and other aspects of the described embodiments are evident in the attached drawings and the text that follows.

### BRIEF DESCRIPTION OF THE SEVERAL VIEWS OF THE DRAWING

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is a diagram of an exemplary system that receives and verifies customer reviews by evaluating the authenticity of a proof-of-purchase provided by a customer in accordance with one embodiment.

FIG. 2 illustrates an exemplary web based interface allowing users to submit proof-of-purchase and verify a review, according to the embodiment of FIG. 1.

FIG. 3 is a diagram depicting exemplary modules invoked by the review verification web server according to the embodiment of FIG. 1.

FIG. 4 is a flowchart of the processing steps associated with an exemplary proof-of-purchase data analysis module 200 according to the embodiment of FIG. 3.

FIG. 5 is a flowchart of exemplary processing steps associated with the meta data analysis module 300 according to the embodiment of FIG. 3.

FIG. 6 is a flowchart of exemplary processing steps associated with the user profile analysis module 400 according to the embodiment of FIG. 3.

### DETAILED DESCRIPTION OF THE INVENTION

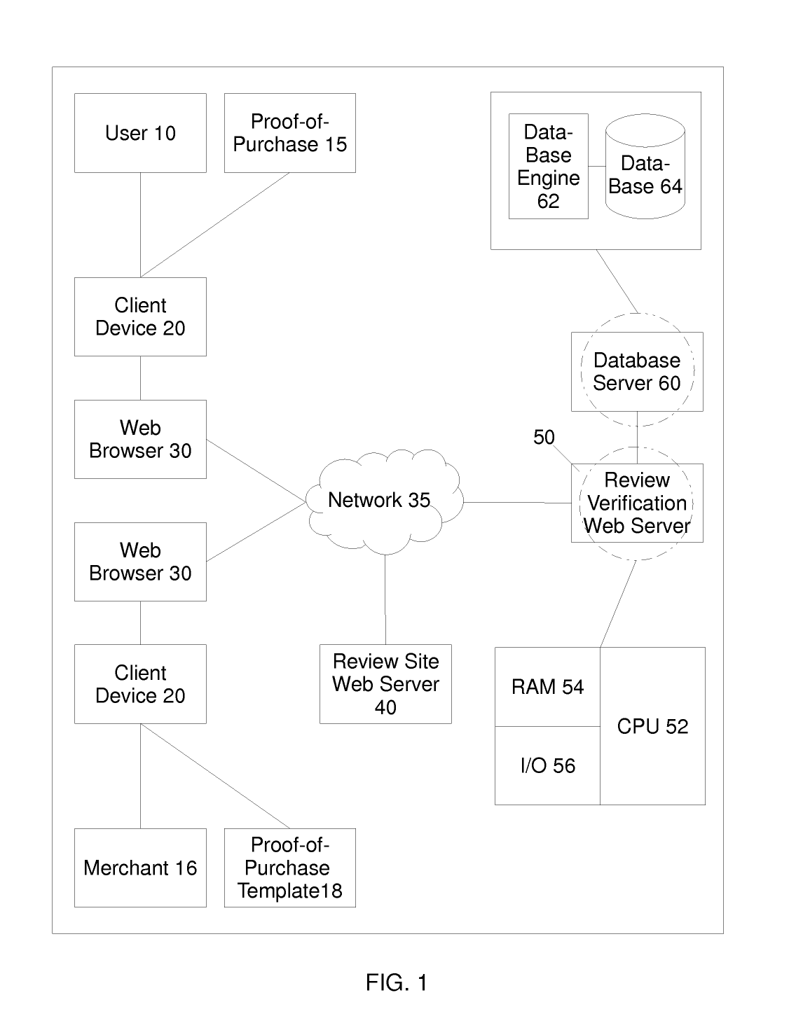

FIG. 1 illustrates a system that receives and verifies customer reviews by evaluating a proof-of-purchase 15 provided by a plurality of users 10 (only one of which is shown in the drawing). The system includes a plurality of client devices 20, each operating a web browser 30 or application capable of accessing one or more networks such as the internet 35 and which connects to a plurality of review site web servers 40 that accept customer reviews (only one of which is shown on the drawing) via one or more networks such as the internet 35. In one embodiment, user 10 then accesses the review verification web server 50 directly to submit a proof-of-purchase and complete a review verification. In another embodiment, the review site web server 40 uses a remote procedure call (e.g. Application Programming Interface) to submit a request to the review verification web server 50 via one or more networks such as the internet 35 to complete a review verification. Review verification web server 50 is in turn connected to a database server 60 directly or via one or more networks such as the internet 35. It will be appreciated that other embodiments may comprise other elements and may be configured in a different manner.

In the illustrated embodiment, a plurality of merchants 16 (only one of which is shown in the drawing) may optionally provide a proof-of-purchase template 18 to the review verification web server 50 through a plurality of client devices 20 (only one of which is shown in the drawing), each operating a web browser or application capable of accessing the internet 35.

The client device 20, when coupled to a web browser 30 or application capable of accessing the internet 35, allows a user 10 to send, receive and display information to and from the communication network, such as the internet 35. In the illustrated embodiment, client device 20 comprises a personal computer of the type generally available in the marketplace, though, in other embodiments it may comprise a smart phone, personal digital assistant, laptop computer, tablet computer, notebook computer, workstation or other computing device capable of executing a web browser or application that accesses the internet 35, or other suitable communication network.

In the illustrated embodiment, the web browser 30 is a conventional web browser of the type generally available in the marketplace, such as Firefox, Chrome and Internet Explorer, though, in other embodiments, the web browser 30 can be a special purpose smart phone application. The web browser 30 executes on the client device 20 and provides the software components for interacting with the review site web sever 40.

In the illustrated embodiment, there are a plurality of review site web servers 40 (only one of which is shown in the drawing) which provides a web based interface that allows the user 10 to read reviews regarding merchants 16 submitted by other users and to submit reviews regarding merchants 16 that the user 10 has used in the past. Optionally, a plurality of review site web servers 40 are in network communication with a review verification web server 50 via the internet 35. The review site web server 40 may be of the type described later in connection with the review verification web server 50.

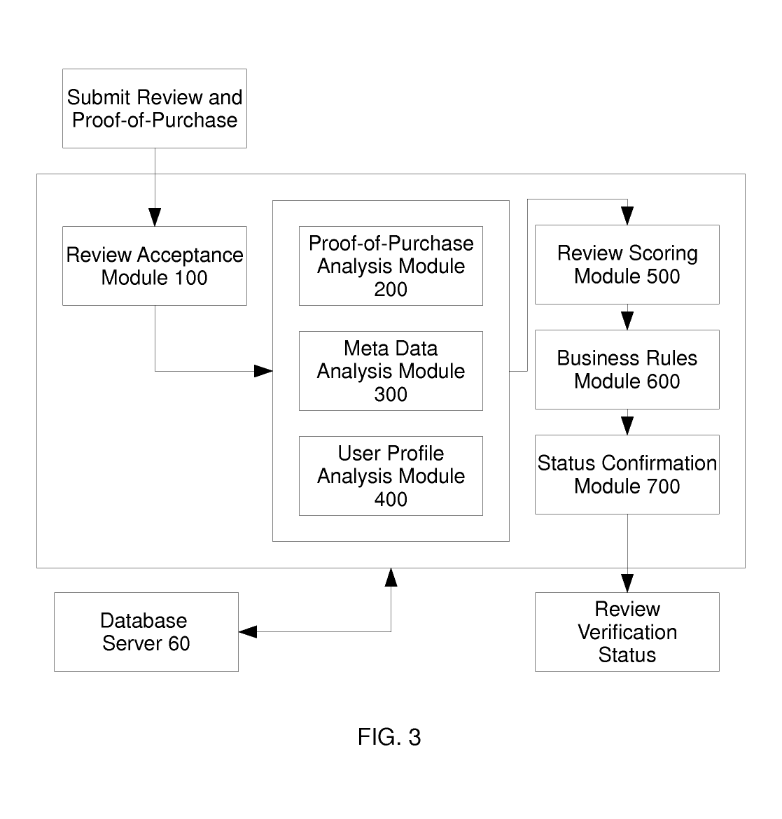

In the illustrated embodiment, the review verification web server 50 comprises a conventional web server that is commercially available in the marketplace. In this illustrated embodiment, software (e.g., NGINX or other suitable server software) operating on the review verification web server 50 further includes or invokes modules that verify a customer review. See FIGS. 3 to 6 and the accompanying descriptions below for further details. In one embodiment, the review verification web server 50 provides a web based interface that allows the user 10 to submit a proof-of-purchase and complete a review verification directly. In another embodiment, the review verification web server 50 may interact with a plurality of review site web servers 40 via remote procedure calls (e.g. Application Programming Interface) to complete a review verification. In one embodiment, the hardware platform that defines the review verification web server 50 has a central processing unit (CPU) 52, memory, such as RAM 54, and input/output (I/O) 56, all of a type that is commercially available in the marketplace for use in such platforms.

In the illustrated embodiment, a database server 60 comprises a conventional database server that is commercially available in the marketplace. The database server 60 is in network communication with the review verification web server 50 and manages the interactions between the database engine 62 and one or more databases 64 (only one of which is shown in the drawing).

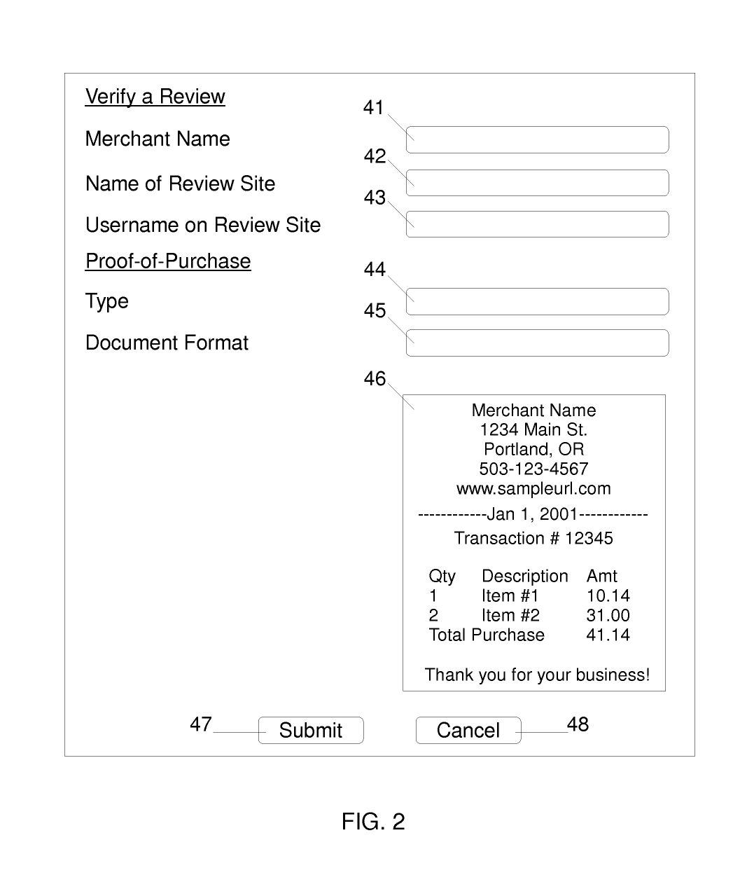

FIG. 2 illustrates an exemplary embodiment of a web based interface provided by the review verification web server 50 that allows a user 10 to verify a review they wrote on a review site 40 by providing the necessary information and submitting a proof-of-purchase 15. After logging in with a user identification and password, the user 10 can use the web interface to provide the necessary information to document that a transaction occurred between the user 10 and a merchant 16 as indicated by the review that they wrote. The user will identify the name of the merchant 16 that they conducted business with by typing it into a text input box 41. The user 10 will then identify the review websites 40 where the user submitted a review for aforementioned merchant 16 by typing in the name of the website into a text input box 42. In another embodiment, the user 10 will be able to select the name of the review website 40 using a drop-down box. In situations where the user 10 submitted reviews for the same merchant at more than one review web site 40, they will be able to request additional text input boxes 42. User 10 will also specify their username for that review site by typing it into a text input box 43.

The user 10 will then upload a digital copy of a merchant-issued receipt or a bank-issued bank statement. User 10 will first specify whether the proof-of-purchase 15 that is being submitted is a receipt or a bank statement using a drop-down box 44. User will then specify the electronic format of the proof-of-purchase 15 using a drop-down box 45 which includes, but is not limited to, Joint Photographic Experts Group (JPEG), Graphics Interchange Format (GIF), Windows bitmap (BMP), Portable Network Graphics (PNG), Tagged Image File Format (TIFF) or Portable Document Format (PDF) as choices.

Once the proof-of-purchase 15 information is specified, user 10 will be given the option to browse the user 10's device's file directory and selects an appropriate proof-of-purchase file to upload. User 10 will have previously created a digital copy of a merchant-issued receipt or bank-issued bank statement by using, but not restricted to, a scanning device, digital camera or smart phone with photographic features. Optionally, user 10 may download an electronic copy of a receipt from the merchant 16 website or download an electronic copy of a bank statement from the bank website.

The review verification web server 50 will load the proof-of-purchase 15 and display it on the webpage as an image 46. In one embodiment, the user 10 will optionally be able to tag proof-of-purchase 15 attributes such as, but no limited to, the merchant 16 name, merchant 16 address, transaction date, receipt number, items purchased, receipt amount, by selecting the area on the proof-of-purchase that contains an attribute and identifying the data attribute that it represents.

Once the review information has been input, the user 10 may submit the review by clicking on the Submit button 47 or may cancel the current review verification by clicking on the Cancel button 48.

FIG. 3 illustrates an exemplary embodiment of the modules invoked by the review verification web server 50 to verify customer reviews by evaluating the authenticity of the proof-of-purchase 15 provided by the customer 10. User 10 submits, via the internet 35 or other suitable network, the review and proof-of-purchase 15 information, which are received by a review acceptance module 100. In an alternative embodiment, a review site web server 40 submits the review and proof-of-purchase 15 information for the user 10 via remote procedure calls (e.g. Application Programming Interface). The review submission may be done in a real time, delayed processing or batch manner.

The review acceptance module 100 verifies that information for completing the verification process is included in the submission as well as other preconditions required for the verification process. In one embodiment, such required information includes one or more of the user identification information, the merchant's name and location, the review site that contains the review, username for that review site, the digital copy of the proof-of-purchase 15, meta data for the digital copy of the proof-of-purchase 15, information regarding where the review verification was submitted (for example, an IP address if from a desktop client device or geographic coordinates if from a mobile application) and information on other reviews written by the user 10, singularly or in any combination. In a preferred embodiment, such information is processed by one or more of the proof-of-purchase data analysis module 200, the meta data analysis module 300 or the user profile analysis module 400, singularly or in any combination. The review acceptance module 100 also verifies that the user 10 has completed required pre-conditions, including, but not limited to, verification of the user 10 email address and verification of the user 10 identity through commercially identify verification services such as IDology.

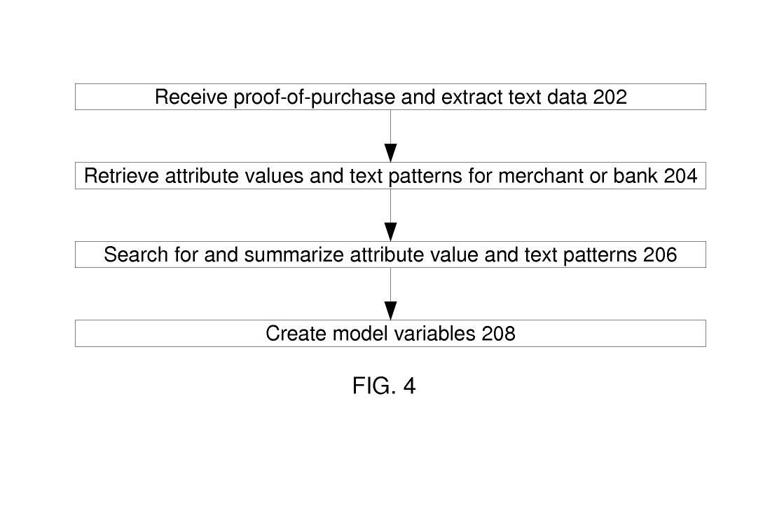

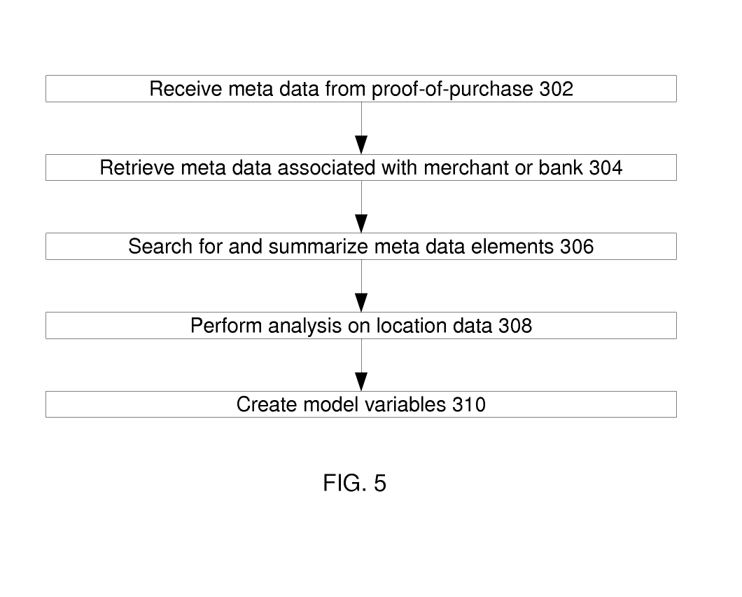

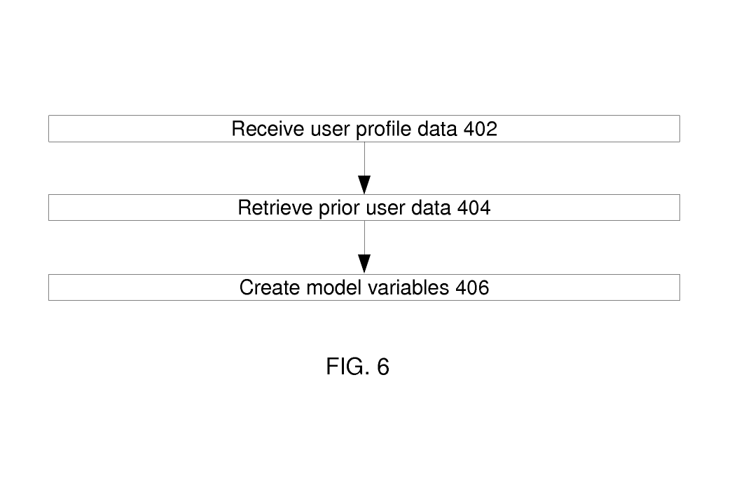

In the illustrated embodiment, the proof-of-purchase data analysis module 200 creates model variables that are used by the review scoring module 500 based on the data contained on the proof-of-purchase 15. See FIG. 4 and the accompanying descriptions below for further details. The meta data analysis module 300 creates model variables that are used by the review scoring module 500 by analyzing the meta data associated with the proof-of-purchase 15. See FIG. 5 and the accompanying descriptions below for further details. The user profile analysis module 400 creates model variables that are used by the review scoring module 500 by analyzing the user profile information. See FIG. 6 and the accompanying descriptions below for further details.

The review scoring module 500 calculates a risk score using the model variables generated by the proof-of-purchase data analysis module 200, the meta data analysis module 300 and the user profile analysis module 400. The use of a statistical model that looks at multiple attributes provides for a more accurate assessment of whether a review is authentic or not. Many approaches use a binary approach to assessing validity based on a single attribute, e.g. can the user 10 verify their email address or telephone number, does the user 10 have a social network profile, was the review submitted with a domestic IP address. The binary approach is prone to false negatives (e.g. review is evaluated as authentic but user 10 used a fake social network login) or false positives (e.g. review is evaluated as fake because user 10 was on a business trip and was accessing their internet in a foreign country). A statistical model that looks at multiple factors makes it more difficult for an individual to falsify a review since multiple aspects of the review and proof-of-purchase 10 are evaluated.

Each model variable is multiplied by its associated regression coefficient to arrive at a contribution value for that variable. Each of the regression coefficients describes the size, or effect, of the contribution of a given variable to the risk of the proof-of-purchase 15 being not authentic. A positive coefficient means that the variable increases the risk score, whereas a negative coefficient means that the variable decreases the risk score. Regression coefficients may be assigned values based on prior statistical analysis of all the potential model variables and how they are related to the probability of a review being falsified. The contribution value for each of the variables is summed, along with an intercept value to arrive at a total contribution value. A logistic function is applied to convert the total contribution into a probability value. An exemplary logistic function is:

f(z)=1/(1+e^{-z})

where z is the total contribution value. The output, f(z) is a probability value between 0 and 1 and indicates the probably that the receipt is not authentic, herein referred to as the risk score. For example, an output of 1 indicates a high probability that the receipt is not authentic.

The exemplary embodiment is based on a logistic regression modeling approach with a predefined set of model variables, regression coefficients and intercept values. However, the review scoring module 500 is meant to be flexible so that model variables, regression coefficients and intercept values can be updated over time to improve accuracy. It will be recognized by those skilled in the art that the review scoring module 500 can be configured to work with different statistical modeling approaches or employ neural network or other machine learning approaches.

The business rules module 600 receives the risk score generated by the review scoring module 500 and applies business rules to determine the review verification status for the submitted review. An exemplary set of business rules comprises determining whether the merchant that is being reviewed has a number of total submitted reviews that falls below a review threshold, for example, 20 reviews or less, preferably 50 reviews or less. If the merchant has a number of prior reviews below the review threshold the review verification status is set to Not Scored thus indicating that there is not enough historical information to determine authenticity. Reviews with a Not Scored review verification status will be re-evaluated once the number of reviews for the merchant is at or above the review threshold, but until then, no further business rules are applied and processing for the review stops. If the number of reviews for the merchant is at or above the review threshold and the risk score is below the threshold set for low risk reviews, for example, 0.05, the review verification status is set to Verified. If the number of reviews for the merchant is at or above the review threshold and the risk score exceeds the threshold set for low risk reviews, for example, 0.05, the review verification status is set to Pending Further Verification, thus indicating that the review is placed in a queue for the user 10 to perform additional verification steps before the review can be accepted. Such additional verification steps may include submitting additional proof-of-purchase 15 documentation or performing additional verifications procedures, such as verifying the user 10 telephone number, within a set amount of time, singularly or in combination. Once the user 10 has satisfactorily completed the additional verification step or steps, the review verification status is updated to Verified. If the user 10 does not complete the verification steps within the set amount of time, the review verification status is updated to Not Verified.

The business rules module 600 is flexible and may be updated with new thresholds for low risk reviews as well as accommodate segmentation schemes based on customer, merchant or other segmentation in order to continually adapt to business conditions. For example, the business rules may employ a stricter risk threshold (e.g. 0.02) for new users (e.g. members who have submitted only 1 review for verification) to be considered Verified to reflect the fact that a new user 10 is more risky given the limited information about that user 10. As another example, as more reviews are gathered, it may be determined that merchants in a particular industry are riskier than other merchants, all else equal, and require a stricter risk threshold. Other suitable business rules may be applied by the business rules module 600. For example, it may be determined that reviews with a very high risk score (e.g. >0.5) are primarily false and instead of being set to Pending Further Verification, should instead be set immediately to Not Verified and the user 10 that submitted the review be flagged as a high risk user 10 so that any future reviews submitted by the user 10 are more closely scrutinized. As an other example, for very high risk reviews (e.g. risk score >0.9) that are more likely to be submitted by professional fraudsters, the business rule may require manual examination by a company fraud investigator because the likelihood that requesting additional verification from the user 10 would not be helpful may exist because the user 10 may falsify the additional documents being requested.

The status confirmation module 700 communicates the review verification status (e.g. Verified, Not Scored, Pending Further Verification or Not Verified). In one embodiment, where the user 10 interacts directly with the review verification web server 50, the status confirmation module will generate a web page which summarizes the verification status for that review as well as other relevant information. The user 10 will be provided with a URL for the review verification status page that they can post onto the review at the review site web server 40 in order to inform other users that their review has been verified. The web page will include, but not be limited to the following information, the merchant 16 name, the name of the review site that the review was written for, the username of the user 10 who wrote the review and non-personally identifiable information, including, but not limited to, information about the user, the type of proof-of-purchase provided by the user 10, the user 10 IP access location. All personally identifiable information will be de-personalized by replacing information that can be trade to an individual user 10 with more generic information. For example, a user's 10 specific IP address (e.g. 11.222.333.44) will be replaced with a broader category (e.g. “Non-US IP Address”). Non-personally identifiable information will retain enough information in order to help third party users who are reading a review understand the context of why a review received a certain review verification status. Furthermore, in situations where the review is “Not Scored”, it will provide the third party user with some factors to consider in lieu of the review verification status. The proof-of-purchase 16 that was provided by the user 10 will not be included on the review verification status page in order to protect the user's 10 privacy, as they may not want certain information on the proof-of-purchase 16 divulged to a broader audience.

If the verification status is Pending Further Verification, the additional verification step is also communicated to the user 10, for example, via electronic mail Once the user 10 completes the additional verification step or steps, the review verification web server 50 will update the review verification status for the user 10′s review. The communications to and from the status confirmation module 700 may be in a real time, delayed processing or batch mode.

In the embodiment where a review site web server 40 uses a remote procedure call (e.g. Application Programming Interface) to submit a request to the review verification web server 50 to complete a review verification, the status confirmation module 700 will provide the review verification status and relevant information back to the review site web server 40 via remote procedure call. The review site web server 40 will then display the review verification status on the user's 10 review.

FIG. 4 is a flowchart illustrating an exemplary embodiment of processing associated with the proof-of-purchase data analysis module 200. Other suitable processing may be associated with the proof-of-purchase data analysis module 200, or with other suitable modules.

At step 202, the proof-of-purchase data analysis module 200 receives the digital copy of the proof-of-purchase 15 that was accepted by the review acceptance module 100 and extracts the text data contained within the proof-of-purchase 15.

In one embodiment, if the user 10 previously tagged the proof-of-purchase 15 attributes, those elements will be received and processed by the proof-of-purchase data analysis module 100. If the proof-of-purchase 15 is an image (e.g. JPEG, GIF, BMP, PNG, TIFF), then the proof-of-purchase data analysis module 100 will receive the name of the attribute that was tagged and the portion of the image that was tagged by the user. The proof-of-purchase data analysis module 100 will then use commercially available optical character recognition (OCR) software to extract the text content from the image data. Optionally, in situations where the image quality is low, the proof-of-purchase data analysis module 100 may use commercially available data entry services to convert the image information into text. Optionally, if the proof-of-purchase 15 is in Portable Document Format (PDF), then OCR software or commercially available document format conversion and text extraction software may be used to extract the text portion of content.

In other embodiments, if the user did not tag the proof-of-purchase 15, the proof-of-purchase data analysis module 100 will use the aforementioned optical character recognition, document format conversion and text extraction software and data entry services to extract the text data contained on the proof-of-purchase 15, singularly or in any combination. Optionally, in other embodiments, the review acceptance module 100 will extract the graphical images (e.g. merchant 16 logos) that are contained on the proof-of-purchase 15.

At step 204, attribute information and text patterns related to the merchant or bank are retrieved from the database server 60. If user 10 submits a receipt, then attribute information and text patterns associated with receipts issued by the merchant 16 are retrieved. If user 10 submits a bank statement, then attribute information and text patterns associated with statements issued by the bank are retrieved. The database server 60 will contain a summary of attribute values and text patterns categorized as either as positive, indicating that is more likely to be from an authentic proof-of-purchase 15 or as negative, indicating that it is more likely to be from a falsified proof-of-purchase 15. Each retrieved attribute value and text pattern will also be categorized based on their importance level. Importance measures the ability for a particular attribute value or text pattern to uniquely distinguish between an authentic and falsified proof-of-purchase.

In the preferred embodiment, the categorized attribute information and text patterns will be fed into the database server 60 based on the results of analyses separately performed by statisticians. For example, in one embodiment, statistical analyses will determine which attributes and text patterns are relevant for a given merchant 16 or bank by calculating the ratio of how frequently a given attribute value or text pattern appears on proof-of-purchase 15 documents for that merchant 16 or bank to the frequency that it appears for other merchants or banks. The higher the ratio, the more likely that the attribute value or text pattern is unique to a given merchant 16 or bank. Attribute values or text patterns that have low ratios, such as the phrase “Thank you for your business” will not be included in the database server 60 as a relevant text pattern for a given merchant 16 or bank.

In one embodiment, the importance of an attribute value or text pattern can be calculated as the ratio of how frequently that attribute or text pattern appears on proof-of-purchase 15 documents previously identified as authentic for a given merchant 16 or bank to the frequently it appears on proof-of-purchase 15 documents previously identified as falsified. Higher ratios indicate higher importance in distinguishing authentic proof-of-purchase 15 documents from falsified ones. As an example, a merchant 16 may operate multiple locations, and for one location the “company name” attribute may have a value that is “Pizza Place #35A”. Since the merchant's 16 location numbering scheme may not be publicly known, that particular attribute value is more likely to only appear on authentic proof-of-purchase 15 documents and not falsified ones since it would be difficult for an individual to guess. Similarly, ratios will be calculated looking at the ratio of the frequency that a attribute value or text pattern appears on a previously identified falsified proof-of-purchase 15 to the frequency it appears on previously identified authentic proof-of-purchase 15 documents in order to identify the importance of negative attribute values and patterns (e.g. those indicating a higher propensity of falsification).

In another embodiment, if the merchant 16 had previously uploaded a proof-of-purchase template 18 document onto the review verification server 50, the proof-of-purchase data analysis module 200 will optionally retrieve attribute values and text patterns specified by the merchant 16 on the proof-of-purchase template 18 document.

Attribute values and text patterns will also be categorized by whether they are merchant-issued receipt based or bank-issued bank statement based.

At step 206, the proof-of-purchase 15 is searched to see if it contains any of the text patterns retrieved from the database server 60 at step 204. Matches are identified and match counts are generated by summarizing the number of matches for each category of text pattern, e.g. Negative Receipt Pattern/Attribute, Negative Statement Pattern/Attribute, Positive Low Importance Receipt Pattern/Attribute, Positive High Importance Receipt Pattern/Attribute, Positive Low Importance Statement Pattern/Attribute and Positive High Importance Statement Pattern/Attribute.

At step 208, model variables are created. Data transformation steps are applied to the categorized text pattern match counts for the proof-of-purchase 15 obtained in step 206 to create normalized variables for use in a review scoring model 500. For example, the match counts for the Positive High Importance Receipt Pattern/Attribute on the submitted receipt for a given user 10 may be indexed to the average match counts for Positive High Importance Receipt Pattern/Attribute for all of the receipts submitted for a particular merchant 16 as a proxy for the quality of the receipt submitted by the user 10.

It will be recognized by those skilled in the art that the attribute element and text pattern categorization approaches, ratio calculations, data transformation and normalization steps and model variables may be updated or modified over time as additional analyses are performed on the proof-of-purchase 15 documents.

FIG. 5 is a flowchart illustrating an exemplary embodiment of the processing steps associated with a meta data analysis module 300.

At step 302, the meta data analysis module 300 receives the meta data for the proof-of-purchase 15 that was accepted by the review acceptance module 100. Meta data may include information contained on the digital copy of the proof-of-purchase 15, including, but not limited to elements such as the format of the file e.g. JPEG, GIF, BMP, PNG, TIFF, PDF), the date and time that the file was created, the author of the file, the program used to create the file, and the location of where the file was captured (e.g. IP address for desktop clients and geographic coordinates for smart phones). Optionally, if the proof-of-purchase was captured using a digital camera, meta data may include the exchangeable image file format (EXIF) information. The meta data analysis module 300 may use the elements singularly or in any combination.

At step 304, if user 10 submits a merchant 16 issued receipt, then meta data associated with the receipts previously submitted for that merchant 16 are retrieved from the database server 60. If user 10 submits a bank statement, then meta data elements associated with statements previously submitted for that bank are retrieved from the database server 60. Each meta data element on the database server 60 is categorized as either a positive or negative element indicating that is more likely to be from an authentic statement or from a falsified statement, and further categorized by importance and whether it is from a merchant 16 issued receipt or bank. In the preferred embodiment, the meta data categorizations will be fed into the database server 60 based on the results of analyses separately performed by statisticians.

In one embodiment, the importance of a meta data element value can be calculated as the ratio of how frequently that meta data element value appears on proof-of-purchase 15 documents previously identified as authentic for a given merchant 16 or bank to the frequently it appears on proof-of-purchase 15 documents previously identified as falsified. Higher ratios indicate higher importance in distinguishing authentic proof-of-purchase 15 documents from falsified ones. As an example, a bank may use an acronym for its name as the value for the author meta data element (e.g. “FiNBPo” for “First National Bank of Portland Oregon Incorporated”) on PDFs that can be download from the bank's online banking site. Since the bank's chosen acronym may not be a publicly known fact, that particular meta data element value is more likely to only appear on authentic proof-of-purchase 15 documents and not falsified ones since it would be difficult to guess. Similarly, ratios will be calculated looking at the ratio of the frequency that a meta data element value appears on a previously identified falsified proof-of-purchase 15 to the frequency it appears on previously identified authentic proof-of-purchase 15 documents in order to identify the importance of negative meta data element values (e.g. those indicating a higher propensity of falsification).

At step 306, the proof-of-purchase 15 meta data is searched to see if it contains any of the meta data elements retrieved from the database server 60 at step 304. Matches are identified and match counts are generated by summarizing the number of matches for each category of meta data element, e.g. Negative Receipt Meta Data, Negative Statement Meta Data, Positive Low Importance Receipt Meta Data, Positive High Importance Receipt Meta Data, Positive Low Importance Statement Meta Data and Positive High Importance Statement Meta Data.

Optionally, at step 308, analysis is done on the location information of where the proof-of-purchase 15 was submitted, if such data is available. If the proof-of-purchase 15 was submitted via a desktop or laptop client device, the IP address of the device will be converted to geographic coordinates using commercially available geocoding services. If the proof-of-purchase 15 was submitted via smart phone, the geographic coordinates will be extracted from the phone's location sensor. The geographic coordinates of the proof-of-purchase 15 submission location will be compared to the geographic coordinates that are stored on the database server 60 for the home zip code provided by the user 10 and the merchant 16 location. The distance between the proof-of-purchase 15 submission location and the the user's 16 home zip code and between the submission location and the merchant location are calculated using commonly used algorithms for geo-spatial search (e.g. Haversine formula) and stored as variables (e.g. “Submission Distance to Home” and “Submission Distance to Merchant”) for later use. Additionally, in one embodiment, the distance between the user's 10 home address and the merchant 16 address is calculated (e.g. “User Home Distance to Merchant”).

At step 310, model variables are created. Data transformation steps are applied to the categorized meta data element match counts for the proof-of-purchase 15 obtained in step 306 to create normalized variables for use in the review scoring model 500. For example, the match counts for the Positive High Importance Receipt Meta Data on the submitted receipt for a given user 10 may be indexed to the average match counts for the Positive High Importance Receipt Meta Data for all of the receipts submitted for a particular merchant to proxy the quality of the meta data elements contained on that receipt.

Optionally, if the proof-of-purchase 15 submitted by the user 10 contains location data, the meta data analysis module 300 will retrieve from the database server 60, the average distance between a user's 10 submission location and the merchant 16 address and the distance between the user's 10 home address and the merchant 16 address for all of other users 10 that previously submitted a proof-of-purchase 15 that was previously identified as authentic for that merchant 16. The distances on the submitted receipt for a given user 10 will be indexed to the average distances for the merchant 16. A high index will indicate that the user 10 travelled a longer distance (as measured by either their home address or proof-of-purchase 15 submission location) than the typical customer that the merchant 16 serves and may present an indication of falsification.

It will be recognized by those skilled in the art that the meta data element categorization approaches, geographic location metrics, ratio calculations, data transformation and normalization steps and model variables may be updated or modified over time as additional analyses are performed on the proof-of-purchase 15 documents.

FIG. 6 is a flowchart illustrating an exemplary embodiment of processing steps associated with a user profile analysis module 400.

At step 402, the user profile analysis module 400 receives the user profile data for the user 10 that was accepted by the review acceptance module 100. User profile data may comprise elements such as the user's 10 username and optionally, if the verification request was submitted by a review site web server 40, the list of other merchants 16 that the user 10 has reviewed, but that were not submitted for verification and the date that user 10 first became a registered user on their site

At step 404, the user's 10 prior data is retrieved from the database server 60. Such data may include items such as the reviews that the user 10 previously submitted for verification and the list of all other merchants 16 that user 10 has reviewed, but that were not submitted for verification. Optionally, if the user 10 had previously completed identity verification, then information on the owners, board of directors, managers and other stakeholders of the merchant 16 being reviewed are retrieved from the database 60. Such information may have been previously obtained from commercially available business database/information services.

At step 406, model variables are created on the user 10 data. Model variables include, but are not limited to the ones described herein. The length of the user's 10 tenure with the review site for the review being submitted for verification as well as the length of the user's longest tenure with any review site associated with the user 10 is calculated, as well as the number of previous reviews submitted for verification summarized by the verification status assigned by the business rules module 600. Higher tenure and a greater number of previously verified reviews are a general proxy for an authentic user 10.

Optionally, if location data is provided, the ratio of the distance from the submission location to merchant 16 location on the current review submitted for verification to the average distance from submission location to merchant 16 location for all other reviews previously submitted by the user 10 for verification. These average distance provide a proxy for the distance that a given user 10 is willing to travel in the normal course of business, so the calculated ratio provides an indication of whether the currently submitted review represents a deviation from the user's 10 typical behavior. Similarly, the ratio of the distance from the home address to merchant 16 location for the current review submitted for verification relative to all reviews previously submitted for verification by the user 10 will be calculated.

Optionally, if the user 10 had previously completed identity verification, the user's 10 name will be compared to the names of the stakeholders of the merchant 16 being reviewed. A flag variable will be created which contains a true/false variable indicating whether there was a match. A positive match indicates a high likelihood of falsification.

The user profile analysis module 400 is flexible so that user 10's historical usage metrics, user 10's historical review metrics, geographic metrics, ratio calculations, data transformation and normalization steps and model variables may be updated or modified.

It will be recognized by those skilled in the art that the analytical approaches, geographic location metrics, data transformation steps and model variables may be updated or modified over time as additional analyses are performed on the proof-of-purchase 15 documents.

1. A method to automatically verify a review by evaluating and determining the authenticity of the proof-of-purchase provided, the method comprising:
(a) receiving merchant review verification information at a computer device wherein the review verification information comprises at least one of a digital copy of a proof-of-purchase, meta data associated with a digital copy of a proof-of-purchase and user profile information;
(b) determining model variables based on evaluating at least one of data contained in a digital copy of a proof-of-purchase, meta data contained in a digital copy of a proof-of-purchase or user profile information;
(c) determining a risk score for the review information, wherein the risk score identifies a probability that a proof-of-purchase is fraudulent based on the model variables; and
(d) determining a review verification status for the review by comparing the risk score against business rules.

2. The method of claim 1, wherein review verification information is received from a plurality of websites via a plurality of devices comprising of desktop clients, smart phones and via a plurality of Application Programming Interfaces.

3. The method of claim 1, wherein a proof-of-purchase comprises one of a merchant-issued receipt or a bank-issued account statement.

4. The method of claim 1, wherein evaluating the data contained in the digital copy of the proof-of-purchase comprises:
(a) extracting text content from the digital copy of the proof-of-purchase;
(b) identifying attribute values and text patterns within the extracted proof-of-purchase text;
(c) matching identified attribute values and text patterns to those previously associated with the merchant or the bank that issued the proof-of-purchase;
(d) categorizing the identified attribute values and text patterns by their importance and whether they are indicative of being an authentic proof-of-purchase or indicative of being a falsified proof-of-purchase;
(e) creating model variables by applying data transformation steps to the attribute values and text patterns.

5. The method of claim 1, wherein evaluating the meta data contained in the digital copy of the proof-of-purchase comprises:
(a) receiving meta data information;
(b) matching meta data elements contained on the proof-of-purchase to meta data previously associated with a merchant or a bank;
(c) categorizing the identified meta data elements by whether they are indicative of being an authentic proof-of-purchase or indicative of being a falsified proof-of-purchase;
(d) creating model variables by applying data transformation steps to the meta data elements.

6. The method of claim 1, wherein evaluating the user profile information comprises:
a) receiving user profile information;
b) calculating variables which evaluate the profile;
c) creating model variables by applying data transformation steps to the user profile variables.

7. The method of claim 1, wherein determining the risk score for the review further comprises:
(a) creating contribution values for each model variable by multiplying each model variable by its associated regression coefficient
(b) determining the total contribution value by summing up all of the individual contribution values and the intercept value
(c) converting the total contribution value into a probability score which indicates the probability that the proof-of-purchase is not authentic using the logistic function.
